(19) United States
(12) Patent Application Publication
(10) Pub. No.: US 2022/0379794 A1
(43) Pub. Date: Dec. 1, 2022

(54) ADJUSTMENT MECHANISM FOR WHEEL SECUREMENT MEMBER OF VEHICLE CARRIER

(71) Applicant: YOTTA INNOVATION CO., LTD., Apia (WS)

(72) Inventor: Stella HUANG, Taipei City (TW)

(21) Appl. No.: 17/329,505

(22) Filed: May 25, 2021

(51) Int. Cl. B60P 3/077

(52) U.S. Cl. CPC B60P 3/077

(57) ABSTRACT

The present invention provides an adjustment mechanism for a wheel securement member of a vehicle carrier, and the vehicle carrier includes a frame and the wheel securement member swingably disposed on the frame. The adjustment mechanism includes a guiding assembly and a positioning assembly. The guiding assembly is adjustably positioned on a guiding rod configured to be disposed on the frame and includes a main body and a coupling member rotatably connected between the main body and the wheel securement member. The positioning assembly is connected with the guiding assembly and includes a biasing portion sleeved on the guiding rod, and the biasing portion is movable relative to the guiding rod between a restricting position and a release position.

### BACKGROUND OF THE INVENTION

### Field of the Invention

The present invention relates to an adjustment mechanism for a wheel securement member of a vehicle carrier.

### Description of the Prior Art

A conventional vehicle carrier includes a frame configured to carry a bicycle, and the bicycle may be secured to the frame by straps, fasteners, clamps, restricting arms, or other restricting mechanisms to avoid movement of wheels of the bicycle for stable transportation.

However, the restricting mechanisms as described above require several steps of operation to assemble and disassemble the bicycle, which is complicated and inconvenient to operate. In addition, the restricting mechanisms cannot effectively restrict movement of the wheels so that the bicycle is easy to dislocate from the frame due to vibration during transportation or unexpected external force, which has poor restriction strength and stability.

The present invention is, therefore, arisen to obviate or at least mitigate the above-mentioned disadvantages.

### SUMMARY OF THE INVENTION

The main object of the present invention is to provide an adjustment mechanism for a wheel securement member of a vehicle carrier, which provides easy adjustment and stable restriction.

To achieve the above and other objects, the present invention provides an adjustment mechanism for a wheel securement member of a vehicle carrier. The vehicle carrier includes a frame and the wheel securement member swingably disposed on the frame, and the adjustment mechanism includes a guiding assembly and a positioning assembly. The guiding assembly is adjustably positioned on a guiding rod configured to be disposed on the frame and includes a main body and a coupling member rotatably connected between the main body and the wheel securement member. The positioning assembly is connected with the guiding assembly and includes a biasing portion sleeved on the guiding rod, and the biasing portion is movable relative to the guiding rod between a restricting position and a release position. When the biasing portion is in the restricting position, the biasing portion is biased against the guiding rod, and the guiding assembly is unmovable relative to the guiding rod; when the biasing portion is in the release position, the guiding assembly is movable relative to the guiding rod.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a side view of a control member according to a preferable embodiment of the present invention;

FIG. 4 is a partial cross-sectional view of a preferable embodiment of the present invention when a biasing portion is in a restricting position;

FIG. 5 is a partial enlargement of FIG. 4;

FIG. 6 is a partial cross-sectional view of a preferable embodiment of the present invention when the biasing portion is in a release position;

FIG. 7 is a partial enlargement of FIG. 6;

FIGS. 8-10 are drawings showing operation according to a preferable embodiment of the present invention; and

FIG. 11 is another view of FIG. 9.

### DETAILED DESCRIPTION OF THE PREFERRED EMBODIMENTS

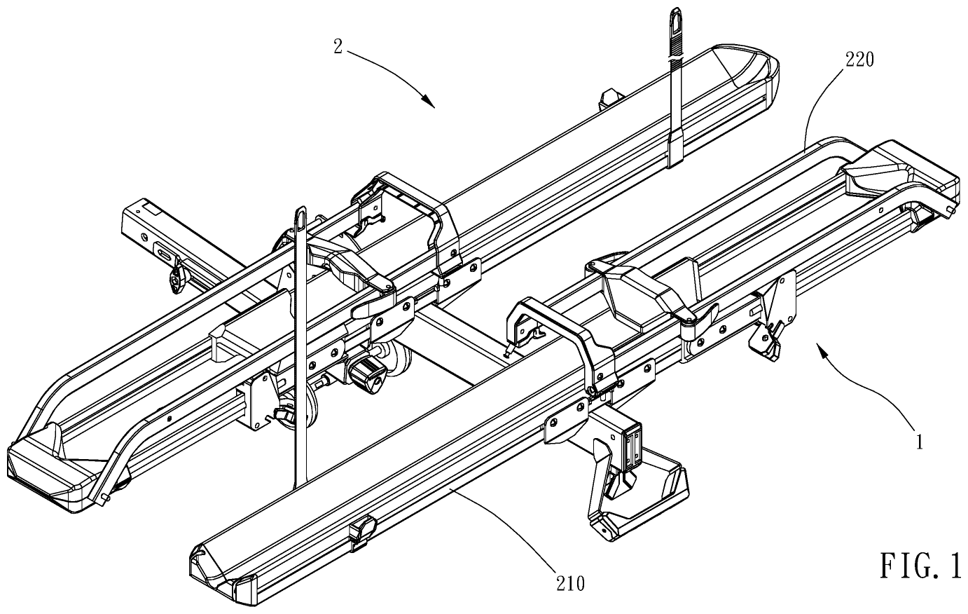

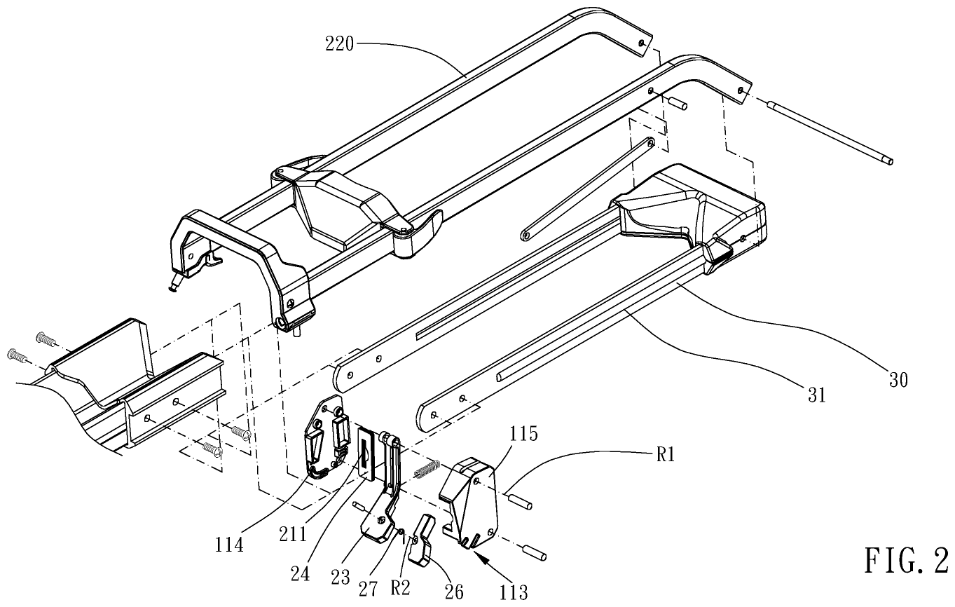

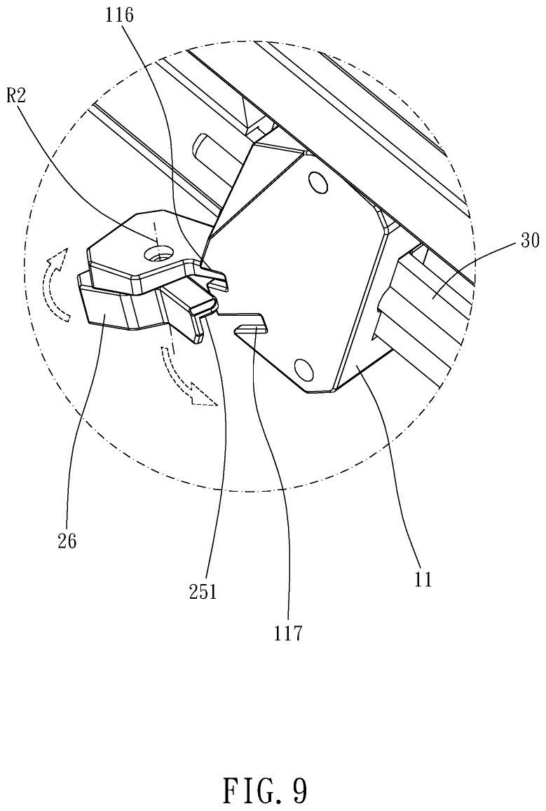

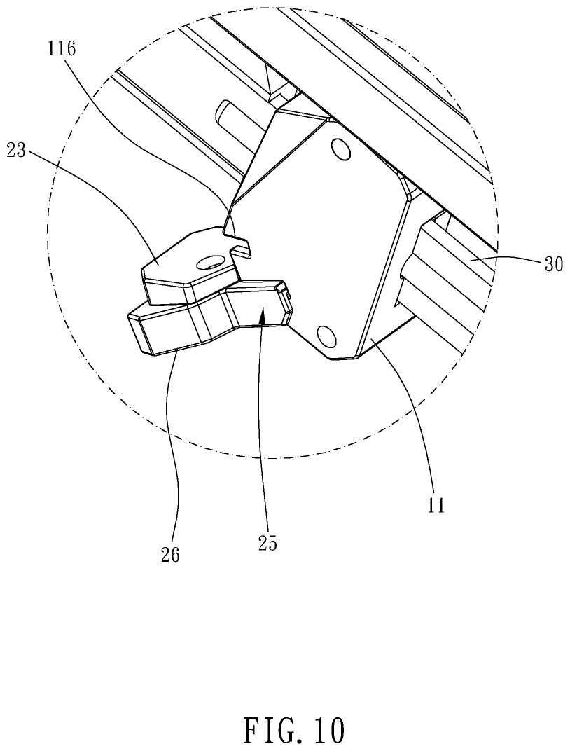

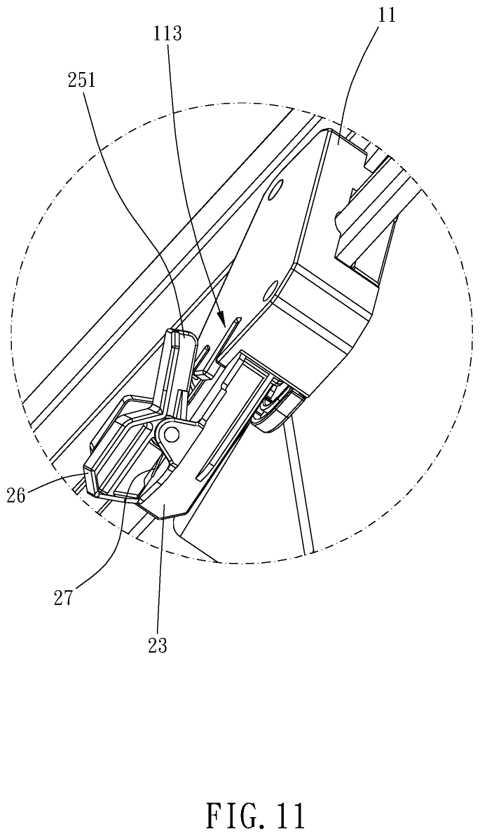

Please refer to FIGS. 1 to 11 for a preferable embodiment of the present invention. An adjustment mechanism 1 of the present invention is configured for a wheel securement member 220 of a vehicle carrier 2, and the vehicle carrier 2 includes a frame 210 and the wheel securement member 220 swingably disposed on the frame 210. The adjustment mechanism 1 includes a guiding assembly 10 and a positioning assembly 20.

The guiding assembly 10 is adjustably positioned on a guiding rod 30 configured to be disposed on the frame 210, and the guiding assembly 10 includes a main body 11 and a coupling member 12 rotatably connected between the main body 11 and the wheel securement member 220. The positioning assembly 20 is connected with the guiding assembly 10 and includes a biasing portion 21 sleeved on the guiding rod 30, and the biasing portion 21 is movable relative to the guiding rod 30 between a restricting position and a release position. When the biasing portion 21 is in the restricting position, the biasing portion 21 is biased against the guiding rod 30, and the guiding assembly 10 is unmovable relative to the guiding rod 30. When the biasing portion 21 is in the release position, the guiding assembly 10 is movable relative to the guiding rod 30. Therefore, the adjustment mechanism 1 of the vehicle carrier 2 has advantages of easy adjustment and stable engagement.

The guiding rod 30 defines an axial direction A, and an outer surface of the guiding rod 30 has at least one convex portion 31 radially protruding therefrom and extending in the axial direction A. The biasing portion 21 includes a through slot 211, and a shape of the through slot 211 corresponds to a radial cross-sectional profile of the guiding rod 30, which provides good guiding effect and stable engagement. Preferably, the positioning assembly 20 is rotatably disposed on the main body 11, and the main body 11 includes a first abutting surface 111 and a second abutting surface 112 which are respectively interferable with the positioning assembly 20 in a rotational direction of the positioning assembly 20. Specifically, the first abutting surface 111 is tilted to the axial direction A, and the second abutting surface 112 is vertical to the axial direction A. The positioning assembly 20 is disposed between the first abutting surface 111 and the second abutting surface 112, which prevents the positioning assembly 20 from being over-swung during adjustment. In this embodiment, the main body 11 further includes a first housing 114 and a second housing 115 connected with each other, and the positioning assembly 20 is disposed between the first housing 114 and the second housing 115, which has a simple structure and is easy to manufacture and assemble.

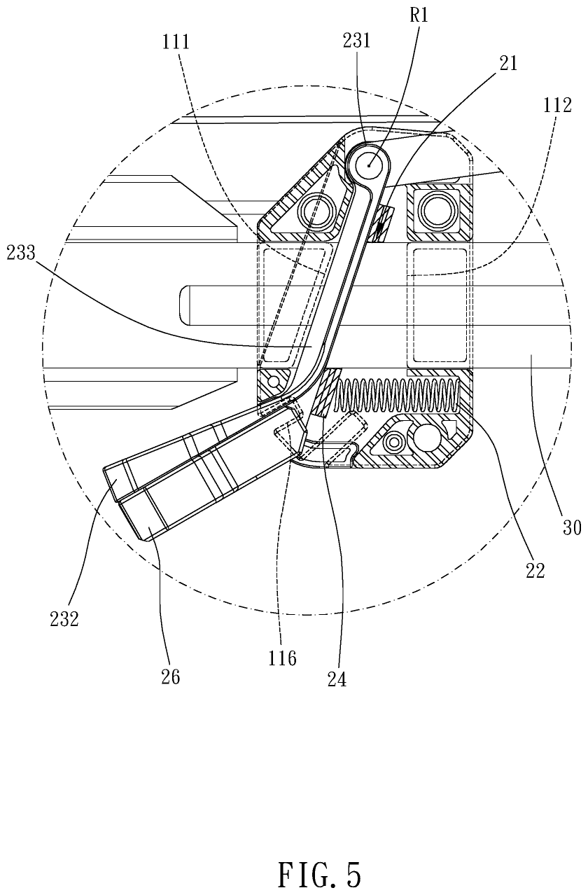

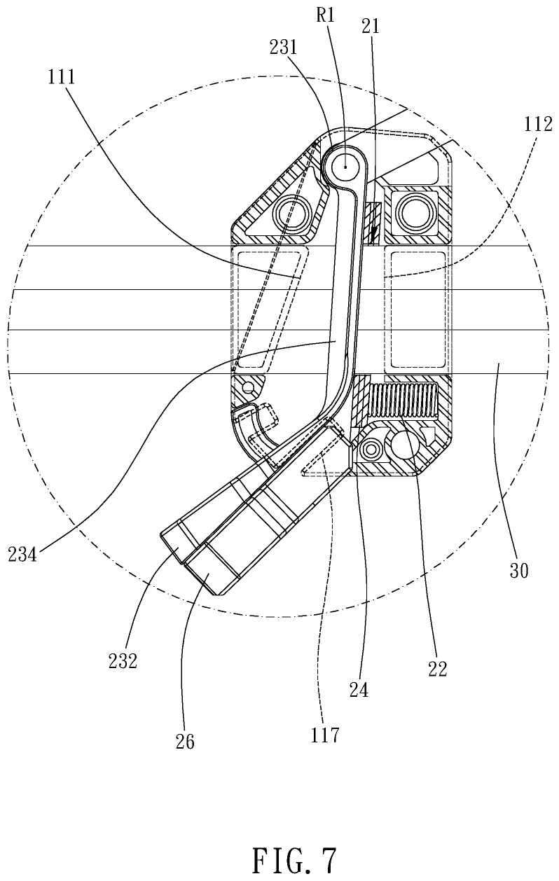

Specifically, the positioning assembly 20 further includes a control member 23, and the biasing portion 21 is drivable by the control member 23. The control member 23 includes a pivot portion 231 rotatably connected with the main body 11, an operation portion 232 protruding beyond the main body 11 and a swinging portion 233 which is connected between the pivot portion 231 and the operation portion 232 and sleeved to the guiding rod 30. The positioning assembly 20 further includes at least one restriction member 24 having the biasing portion 21 disposed thereon, and the at least one restriction member 24 is located between the swinging portion 233 and the main body 11 so that the control member 23 can drive the at least one restriction member 24 to move. In this embodiment, the positioning assembly 20 includes a plurality of said restriction members 24, and the plurality of said restriction members 24 are preferably movable relative to one another. When the biasing portion 21 is in the restricting position, the plurality of said restriction members 24 are tilted relative to the guiding rod 30 and radially biased against the guiding rod 30, as shown in FIG. 5, so that the wheel securement member 220 is non-swingable relative to the frame 210 and is stably restricted. When the biasing portion 21 is in the release position, each of the plurality of said restriction members 24 and the guiding rod 30 has a gap radially disposed therebetween, as shown in FIG. 7, which allows the guiding assembly 10 to be moved along the guiding rod 30 and drive the coupling member 12 and the wheel securement member 220 to swing relative to the frame 210. Preferably, the positioning assembly 20 further includes a first elastic member 22 disposed between the main body 11 and the biasing portion 21 so that the biasing portion 21 has a tendency to move toward the restricting position. In this embodiment, the first elastic member 22 is elastically abutted against and between the main body 11 and one of the plurality of said restriction members 24, and the first elastic member 22 is elastically abutted against a side of the plurality of said restriction members 24 adjacent to the operation portion 232 so that the plurality of said restriction members 24 and the control member 23 have a tendency to be tilted relative to the axial direction A. In other embodiments, the plurality of said restriction members may be fixedly attached with one another; the positioning assembly may have only one said restriction member; the plurality of said restriction members may be attached to the swinging portion; the first elastic member may be disposed between the control member and the main body.

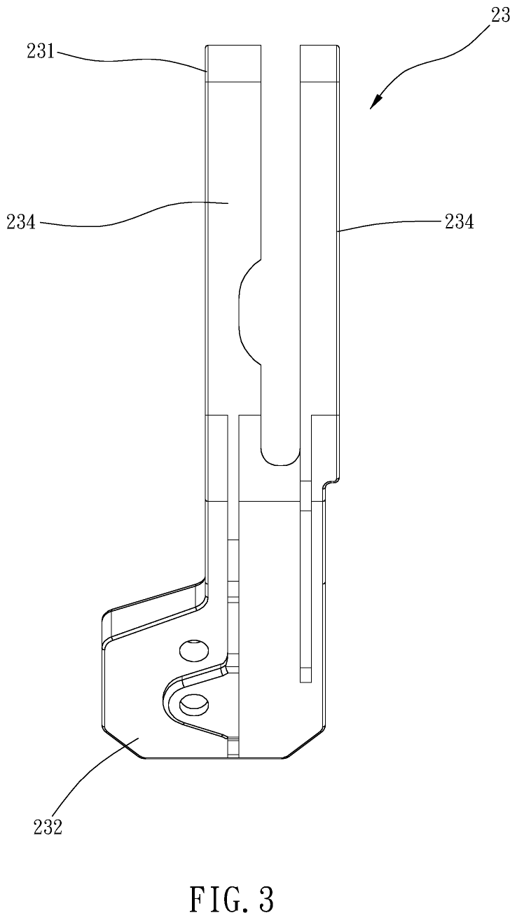

Specifically, the swinging portion 233 includes two arms 234 disposed on two opposite sides of the guiding rod 30, and a surface of each of the two arms 234 facing the guiding rod 30 at least partially corresponds to an outer profile of the guiding rod 30, as shown in FIG. 3. Therefore, the two arms 234 are abuttable against two opposite sides of the plurality of said restriction members 24 for good guiding effect and smooth movement. An extending direction of each of the two arms 234 is oblique to an extending direction of the operation portion 232 so that the operation portion 232 is convenient to operate. In this embodiment, the coupling member 12 is rotatably connected with the pivot portion 231 so as to be easy to assemble and be directly driven when the main body 11 is moved relative to the guiding rod 30. However, the coupling member may be connected with other portions of the main body; the biasing portion may be directly formed on the control member without the plurality of said restriction members.

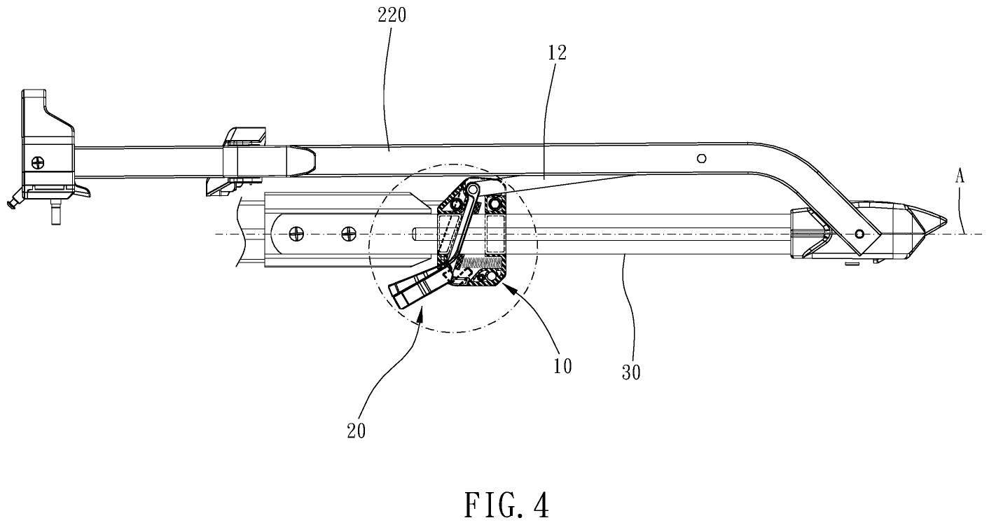

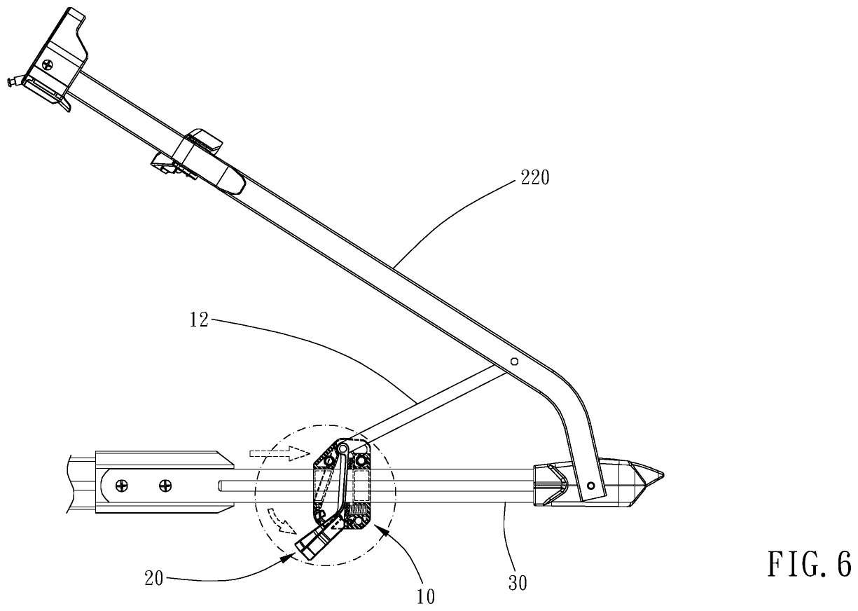

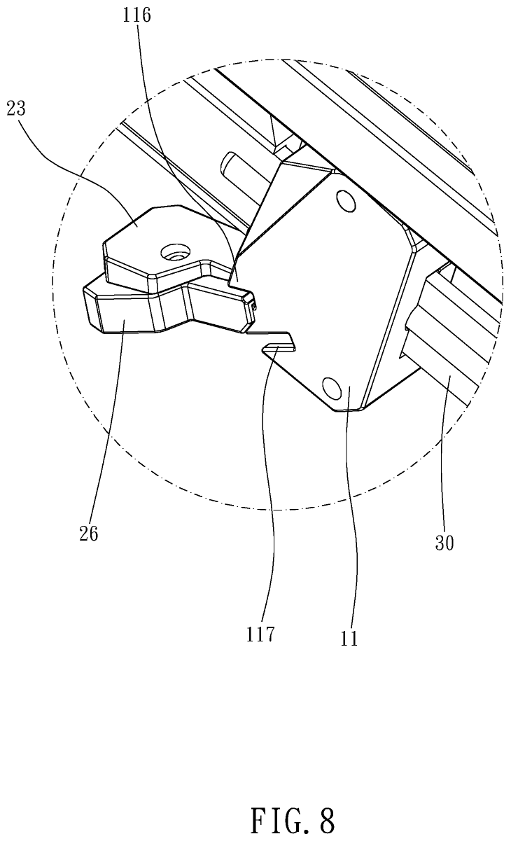

Please refer to FIGS. 8 to 11, the main body 11 further includes at least one first engaging portion 113, and the positioning assembly 20 further includes at least one second engaging portion 25 which is releasably engaged with the at least one first engaging portion 113. When the at least one first engaging portion 113 is engaged with the at least one second engaging portion 25, the biasing portion 21 is in one of the restricting position and the release position. Therefore, the control member 23 is unnecessary to be pressed during adjustment of the wheel securement member 220, which is convenience to use. The positioning assembly 20 further includes a positioning member 26 disposed on the control member 23, and the positioning member 26 has the at least one second engaging portion 25 disposed thereon. When the at least one first engaging portion 113 is engaged with the at least one second engaging portion 25, the control member 23 is unmovable relative to the main body 11. In this embodiment, the control member 23 is rotatably connected with the main body 11 about a first rotational direction R1, and the positioning member 26 is rotatably connected with the control member 23 about a second rotational direction R2 lateral to the first rotational direction R1 so as to avoid unexpected movement of the positioning member 26; the positioning member 26 is disposed on the operation portion 232 so as to be convenient to be operated and adjusted by one hand. Moreover, the at least one first engaging portion 113 includes a first engaging groove 116 and a second engaging groove 117, and the at least one second engaging portion 25 includes a projection 251. When the projection 251 is engaged within the first engaging groove 116, the biasing portion 21 is in the restricting position, as shown in FIGS. 4, 5 and 8. When the projection 251 is engaged within the second engaging groove 117, the biasing portion 21 is in the release position, as shown in FIGS. 6, 7 and 10. Therefore, the main body 11 is movable along the guiding rod 30 to drive the coupling member 12 to swing the wheel securement member 220 relative to the frame 21, which is convenient to assemble and disassemble a bicycle. In operation, the projection 251 is moved from the first engaging groove 116 to the second engaging groove 117 so that the biasing portion 21 is positioned in the release position and the wheel securement member 220 is swingable relative to the frame 21 to a predetermined position. After assembling or disassembling of the bicycle, the projection 251 is engaged within the first engaging groove 116 so that the biasing portion 21 is positioned in the restricting position and the wheel securement member 220 is restricted to the predetermined position. Preferably, the positioning assembly 20 further includes a second elastic member 27 disposed between the positioning member 26 and the control member 23 so that the projection 251 has a tendency to engage within one of the first engaging groove 116 and the second engaging groove 117.

In summary, the biasing portion of the adjustment mechanism is swingable between the restricting position and the release position relative to the guiding rod, which is convenient to adjust and restrict the wheel securement member and provides easy assembling/disassembling and wide application. In addition, with two-stage operation of the positioning member and the control member, the biasing portion is stably positioned in the restricting position or the release position without operating the positioning assembly during adjustment, which avoids unexpected movement of the biasing portion and can be operated by one hand.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An adjustment mechanism for a wheel securement member of a vehicle carrier, the vehicle carrier including a frame and the wheel securement member swingably disposed on the frame, the adjustment mechanism including:
a guiding assembly, adjustably positioned on a guiding rod configured to be disposed on the frame, including a main body and a coupling member rotatably connected between the main body and the wheel securement member; and
a positioning assembly, connected with the guiding assembly, including a biasing portion sleeved on the guiding rod, the biasing portion being movable relative to the guiding rod between a restricting position and a release position;
wherein when the biasing portion is in the restricting position, the biasing portion is biased against the guiding rod, and the guiding assembly is unmovable relative to the guiding rod; when the biasing portion is in the release position, the guiding assembly is movable relative to the guiding rod.

2. The adjustment mechanism of claim 1, wherein the guiding rod defines an axial direction, an outer surface of the guiding rod has at least one convex portion radially protruding therefrom and extending in the axial direction, the biasing portion includes a through slot, and a shape of the through slot corresponds to a radial cross-sectional profile of the guiding rod.

3. The adjustment mechanism of claim 1, wherein the positioning assembly is rotatably disposed on the main body, the main body includes a first abutting surface and a second abutting surface which are respectively interferable with the positioning assembly in a rotational direction of the positioning assembly.

4. The adjustment mechanism of claim 1, wherein the positioning assembly further includes a first elastic member disposed between the main body and the biasing portion.

5. The adjustment mechanism of claim 1, wherein the positioning assembly further includes a control member, the biasing portion is drivable by the control member, and the control member includes a pivot portion rotatably connected with the main body, an operation portion protruding beyond the main body and a swinging portion which is connected between the pivot portion and the operation portion and sleeved to the guiding rod.

6. The adjustment mechanism of claim 5, wherein the positioning assembly further includes at least one restriction member having the biasing portion disposed thereon, and the at least one restriction member is located between the swinging portion and the main body.

7. The adjustment mechanism of claim 1, wherein the main body includes at least one first engaging portion, the positioning assembly further includes at least one second engaging portion which is releasably engaged with the at least one first engaging portion; and when the at least one first engaging portion is engaged with the at least one second engaging portion, the biasing portion is in one of the restricting position and the release position.

8. The adjustment mechanism of claim 7, wherein the positioning assembly further includes a control member and a positioning member connected with the control member, the biasing portion is drivable by the control member, the positioning member has the at least one second engaging portion disposed thereon, and when the at least one first engaging portion is engaged with the at least one second engaging portion, the control member is unmovable relative to the main body.

9. The adjustment mechanism of claim 8, wherein the control member is rotatably connected with the main body about a first rotational direction, and the positioning member is rotatably connected with the control member about a second rotational direction lateral to the first rotational direction.

10. The adjustment mechanism of claim 9, wherein the guiding rod defines an axial direction, an outer surface of the guiding rod has at least one convex portion radially protruding therefrom and extending in the axial direction, the biasing portion includes a through slot, and a shape of the through slot corresponds to a radial cross-sectional profile of the guiding rod; the positioning assembly is rotatably disposed on the main body, the main body includes a first abutting surface and a second abutting surface which are respectively interferable with the positioning assembly in a rotational direction of the positioning assembly; the first abutting surface is tilted to the axial direction, and the second abutting surface is vertical to the axial direction; the control member includes a pivot portion rotatably connected with the main body, an operation portion protruding beyond the main body and a swinging portion which is connected between the pivot portion and the operation portion and sleeved to the guiding rod; the coupling member is rotatably connected with the pivot portion, and the positioning member is disposed on the operation portion; the swinging portion includes two arms disposed on two opposite sides of the guiding rod, a surface of each of the two arms facing the guiding rod at least partially corresponds to an outer profile of the guiding rod; an extending direction of each of the two arms is oblique to an extending direction of the operation portion; the positioning assembly further includes a plurality of restriction members having the biasing portion disposed thereon, the plurality of restriction members are movable relative to one another and are located between the swinging portion and the main body; when the biasing portion is in the release position, each of the plurality of restriction members and the guiding rod has a gap radially disposed therebetween; the positioning assembly further includes a first elastic member located between the main body and one of the plurality of restriction members; the first elastic member is elastically abutted against a side of the plurality of restriction members adjacent to the operation portion; the main body includes a first housing and a second housing connected with each other, the positioning assembly is disposed between the first housing and the second housing; the at least one first engaging portion includes a first engaging groove and a second engaging groove, the at least one second engaging portion includes a projection; when the projection is engaged within the first engaging groove, the biasing portion is in the restricting position; when the projection is engaged within the second engaging groove, the biasing portion is in the release position; and the positioning assembly further includes a second elastic member disposed between the positioning member and the control member.
